(19) United States
(12) Patent Application Publication
(10) Pub. No.: US 2016/0042674 A1
(43) Pub. Date: Feb. 11, 2016

(54) ILLUMINATED FOAM HAND

(71) Applicant: Chris Camarella, Sun Valley, CA (US)

(72) Inventor: Chris Camarella, Sun Valley, CA (US)

(21) Appl. No.: 14/453,852

(22) Filed: Aug. 7, 2014

(51) Int. Cl. G09F 21/02

(52) U.S. Cl. CPC G09F 21/02

(57) ABSTRACT

A display wearable by a user on one hand, comprising a body simulating a hand including a palm, a plurality of simulated fingers, and a simulated thumb. The body is light transmissive and comprises a wall of sythetic resin foam constituent material, is hollow, is greater in size than any human hand, and has an opening enabling the user to insert the hand into the body. The display includes an illumination circuit carried aboard the display, comprising a battery cell, a plurality of light emitting diodes, electrical conductors connecting the battery cell to the plurality of light emitting diodes, and a switch accessible to the user. The, wherein the switch is operable to open and close the illumination circuit. The hand may be arranged with a simulated forefinger bent to contact the simulated thumb, thereby conveying an informal “OK” message, or may have the simulated forefinger straight with the other fingers curled against the palm, thereby conveying a “Number One” message.

### FIELD OF THE INVENTION

The present invention relates to displays, and more particularly, to an oversized hand worn simulated hand.

### BACKGROUND OF THE INVENTION

A popular device for displaying feelings at sports venues is an oversized simulated hand, which is typically worn as a glove on one hand. Such devices are usually fabricated from a closed cell synthetic resin foam. Despite their enduring popularity, such devices may be improved to further emphasize or accentuate messages being conveyed thereby.

### SUMMARY OF THE INVENTION

The present invention provides oversized simulated hands of the type described above, improved by addition of illumination, and by reconfiguring the simulated hand to convey specific non-verbal messages. This is in contrast to conventional such devices, in which, typically, the fingers are either straight and spread apart, or straight and abutting. Illumination is preferably generated by light emitting diodes (hereinafter, LEDs) carried within the constituent material of the glove. The LEDs are powered by a battery or battery cell carried aboard the glove. A circuit connecting the battery (or battery cell) to the LEDs is controlled by a switch.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side view of a display according to at least one aspect of the invention;

FIG. 2 is a side view of a display according to at least one other aspect of the invention;

FIG. 3 is a diagrammatic cross sectional view of a display according to at least one aspect of the invention; and

FIG. 4 is an electrical schematic of an illumination circuit of a display according to at least one aspect of the invention.

### DETAILED DESCRIPTION

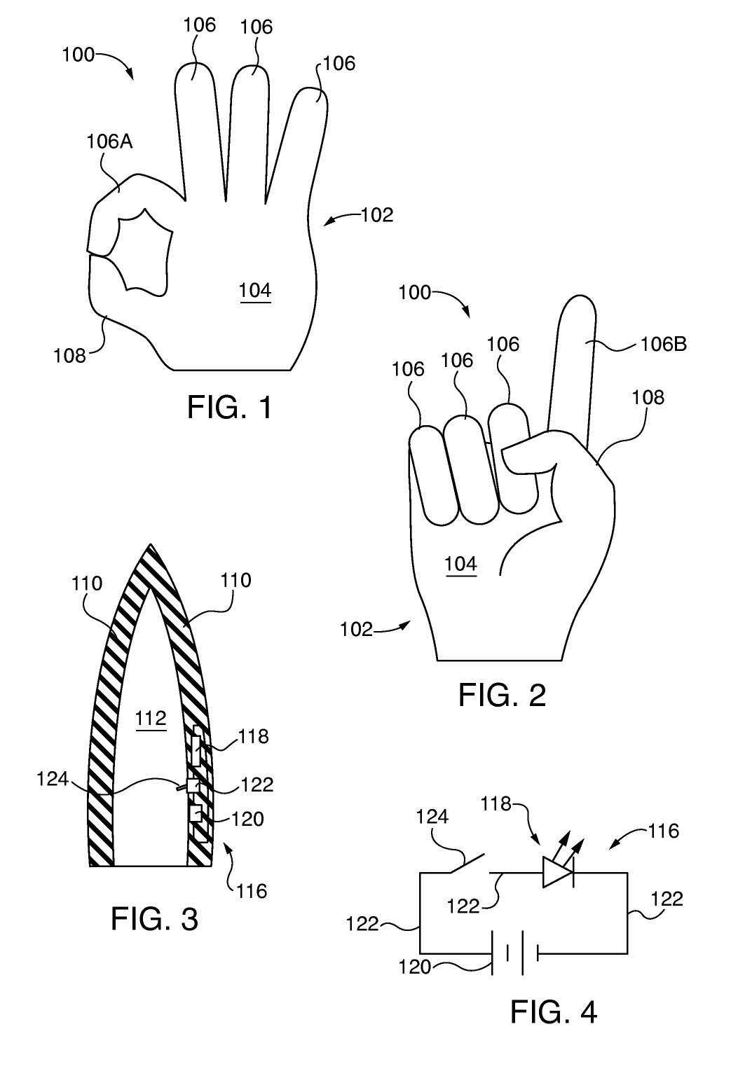

Referring first to FIG. 1, according to at least one aspect of the invention, there is shown a display 100 wearable by a user (not shown) on one hand. The display 100 comprises a body 102 simulating a hand of a person (not shown). The body 102 includes a palm 104, a plurality of simulated fingers 106 and a simulated thumb 108 projecting from the palm 104. The body 102 is light transmissive, comprising a wall 110 (see FIG. 3) of synthetic resin foam constituent material. The body 102, which is greater in size than any human hand (not shown) is hollow, the wall 110 encircling an open interior or void 112. The body 102 has an opening 114 enabling the user to insert his or her hand into the body 102. In this manner, the display 100 can be worn in a manner similar to that of a glove, and may be waved or otherwise moved to attract attention, disseminate a message, and for other purposes.

Referring to FIGS. 3 and 4, an illumination circuit 116 is carried aboard the display 100. The illumination circuit 116 includes at least one light source contained within the wall 110 of the body 102. In an embodiment, the light source comprises a plurality of LEDs 118. These LEDs 118 may be mounted on a common board, may be individual, or may be a combination of these arrangements. The LEDs 118 may vary in size, spacing and layout, color, and in other ways. Therefore, it will be understood that the showings in FIGS. 3 and 4 are diagrammatic or symbolic only, and should not be construed to include only one LED 118.

The illumination circuit 116 also comprises a battery cell 120, electrical conductors 122 connecting the battery cell 120 to the light emitting diodes 118 , and a switch 124 accessible to the user. The electrical conductors 122 are shown diagrammatically, and will be understood to include any number and arrangement of electrical conductors 122 required to illuminate the LEDs 118 according to any desired illumination scheme. The switch 124 is operable to open and close the illumination circuit 116, thereby selectively illuminating and extinguishing the LEDs 118.

The battery cell 120, at least some of the LEDs 118, and the electrical conductors 122 are contained inside the wall 110 of the body 102. Light from the LEDs 118 is visible at the exterior of the display 100 due to light transmissivity thereof.

Light transmissivity of the body 102 may be accomplished in several ways. In an example, the synthetic resin foam constituent material of the body 120 is an open cell foam. Light may pass through small openings in the open cell foam. In another example, the synthetic foam constituent material may be fully or partially is translucent or transparent. If desired, the body could be fabricated from a number of dissimilar materials so that any combination of the above recited characteristics is present. Where present, opacity may be conferred by, for example, depositing paint or other opaque materials on the body 102. Illustratively, legends, logos, and other indicia could be located on the body 102.

Turning again to FIG. 1, the plurality of simulated fingers 106, 106A and the simulated thumb 108 are permanently arranged such that one of the simulated fingers (i.e., the finger 106A) is bent to meet the simulated thumb 108, and the other ones 106 of the simulated fingers are permanently straight. As employed herein, permanence of the simulated fingers 106, 106A and the simulated thumb 108 signifies that the described arrangement of these digits is determined in fabrication. For example, the body 102 may be fabricated from die cut sheets of foam material, shaped and painted or otherwise marked to define the simulated fingers 106, 106A and the simulated thumb 108. It may be possible to deform the body 102 to alter configuration of the simulated fingers 106, 106A and the simulated thumb 108 by, for example, forcefully manipulating them. However, in the absence of forces specifically altering their configuration, the digits will maintain the depicted arrangement. In FIG. 1, the arrangement of the simulated fingers 106, 106A and the simulated thumb 108 is a commonly used and widely recognizable indication of approval, or alternatively stated, an “OK” message.

In the depiction of FIG. 2, one (i.e., 106B) of the plurality of simulated fingers 106 proximate the simulated thumb 108 is permanently straight, and the other ones 106 of the simulated fingers 106 and the simulated thumb 108 are permanently curled against the palm. This arrangement is a commonly used and widely recognizable indication of “Number One”. This is a message which might be displayed at a sports venue (not shown) for example, in support of a preferred sports team.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A display wearable by a user on one hand, comprising:
a body simulating a hand including a palm, a plurality of simulated fingers projecting from the palm, and a simulated thumb projecting from the palm, wherein the body is light transmissive and comprises a wall of synthetic resin foam constituent material, is hollow, is greater in size than any human hand, and has an opening enabling the user to insert the hand into the body; and
an illumination circuit carried aboard the display, wherein the illumination circuit includes at least one light source contained within the wall of the body.

2. The display of claim 1, wherein the illumination circuit comprises a battery cell, a plurality of light emitting diodes, electrical conductors connecting the battery cell to the plurality of light emitting diodes, and a switch accessible to the user, wherein the switch is operable to open and close the illumination circuit.

3. The display of claim 2, wherein the battery cell, at least some of the plurality of light emitting diodes, and the electrical conductors are contained inside the wall of the body.

4. The display of claim 1, wherein the synthetic resin foam constituent material is an open cell foam.

5. The display of claim 1, wherein the synthetic resin foam constituent material is translucent or transparent.

6. The display of claim 1, wherein the plurality of simulated fingers and the simulated thumb are permanently arranged such that one of the simulated fingers is bent to meet the simulated thumb, and the other ones of the simulated fingers are permanently straight.

7. The display of claim 1, wherein that one of the plurality of simulated fingers proximate the simulated thumb is permanently straight, and the other ones of the simulated fingers and the simulated thumb are permanently curled against the palm.
